(19) United States
(12) Patent Application Publication
(10) Pub. No.: US 2026/0143275 A1
(43) Pub. Date: May 21, 2026

(54) CONNECTION STRUCTURE, HEADPHONE, AND HEADPHONE SYSTEM

(71) Applicant: SUUNTO SPORTS TECHNOLOGY (DONGGUAN) CO., LTD., Dongguan (CN)

(72) Inventors: Junlin CHEN, Dongguan (CN); Zhonglin ZHANG, Dongguan (CN)

(21) Appl. No.: 19/403,284

(22) Filed: Nov. 28, 2025

Related U.S. Application Data
(63) Continuation of application No. PCT/CN2025/117798, filed on Aug. 29, 2025.

(30) Foreign Application Priority Data
Aug. 30, 2024 (CN) 202422134367.4

(51) Int. Cl. H04R 1/10

(52) U.S. Cl. CPC H04R 1/1066; H04R 1/1008; H04R 1/1025; H04R 1/1041; H04R 1/105; H04R 2460/13

(57) ABSTRACT

Provided is a connection structure including a mounting box and a connection assembly connected to the mounting box. The mounting box has a connection hole in communication with an external environment. The connection hole is configured to receive the connection assembly. The connection assembly includes a connection body and a connection member. At least part of the connection member is sleeved on the connection body. The connection body and the connection member are integrally formed through two-color injection molding. The at least part of the connection member sleeved on the connection body protrudes in a direction in a direction away from the connection body to form a sealing portion of an annular shape. The sealing portion abuts against a sidewall of the connection hole.

### CROSS-REFERENCE TO RELATED APPLICATION

This application is a continuation of International Application No. PCT/CN2025/117798, filed on Aug. 29, 2025, which claims priority to and benefit of Chinese Patent Application No. 202422134367.4, filed with China National Intellectual Property Administration on Aug. 30, 2024, the entire contents of which are incorporated herein by reference.

### FIELD

The present disclosure relates to the field of headphone technologies, and more particularly, to a connection structure, a headphone, and a headphone system.

### BACKGROUND

Typically, a transducer assembly (which may also be a battery box assembly or a control box assembly) is connected to an ear hook. Sealing between the transducer assembly and the ear hook is usually achieved by an additional sealing ring. In an example, the sealing is achieved through assembling the sealing ring onto the transducer assembly or the ear hook and then injecting a sealing adhesive.

### SUMMARY

Embodiments of the present disclosure provide a connection structure, a headphone, and a headphone system.

A connection structure according to an embodiment of the present disclosure includes a mounting box and a connection assembly. The mounting box has a connection hole in communication with an external environment. The connection assembly is connected to the mounting box. The connection hole is configured to receive the connection assembly. The connection assembly includes a connection body and a connection member. At least part of the connection member is sleeved on the connection body. The connection body and the connection member are integrally formed through two-color injection molding. The at least part of the connection member sleeved on the connection body protrudes in a direction away from the connection body to form a sealing portion of an annular shape. The sealing portion abuts against a sidewall of the connection hole.

In some embodiments, the connection body has greater hardness than the connection member.

In some embodiments, the connection body is made of polymer, and the connection member is made of polymer.

In some embodiments, the connection member includes a body portion and a protrusion connected to the body portion. An outer side of the protrusion protrudes to form the sealing portion. The connection body includes a first connection portion and a second connection portion connected to the first connection portion. The body portion is sleeved on the first connection portion, and the protrusion is sleeved on the second connection portion. The first connection portion is provided with a protuberance at a side of the first connection portion. The side of the first connection portion is close to the second connection portion, and the protuberance extends towards the connection member. The body portion has a recess formed on an inner side of the body portion, and the protuberance is engaged in the recess.

In some embodiments, the protuberance and the body portion both abut against a sidewall of the mounting box.

In some embodiments, a plurality of sealing portions are provided, and the plurality of sealing portions are arranged sequentially at intervals in an extension direction of the protrusion.

In some embodiments, a first shoulder is formed between the first connection portion and the second connection portion, and a second shoulder is formed between the body portion and the protrusion. The first shoulder is engaged with the second shoulder.

In some embodiments, the connection body further includes a third connection portion extending from the second connection portion. The third connection portion is connected to the sidewall of the connection hole by a sealing adhesive. The third connection portion has a wave pattern formed on an outer sidewall of the third connection portion, and the wave pattern is configured to enhance bonding strength of the sealing adhesive.

In some embodiments, the mounting box has a mounting cavity in communication with the connection hole. The connection body further includes a fourth connection portion extending from the third connection portion. The fourth connection portion is a engagement hook and extends into the mounting cavity to engage with an inner sidewall of the connection hole.

In some embodiments, the third connection portion has a third cavity formed within the third connection portion. The connection structure further includes a fixing member. A part of the fixing member extends into the third cavity, and the other part of the fixing member tightly presses the third connection portion against the sidewall of the connection hole.

In some embodiments, the third connection portion has a third cavity formed within the third connection portion, and the fourth connection portion has a fourth cavity formed within the fourth connection portion. The fourth cavity is in communication with the third cavity. The fourth cavity is configured to provide a deformation space for a force-induced deformation of the fourth connection portion during insertion of the fourth connection portion into the connection hole. The fourth connection portion is configured to, when being inserted in the connection hole in place, restore to an initial shape of the fourth connection portion to engage with the inner sidewall of the connection hole.

In some embodiments, the first connection portion has a first cavity formed within the first connection portion; the second connection portion has a second cavity formed within the second connection portion; the third connection portion has a third cavity formed within the third connection portion; and the fourth connection portion has a fourth cavity formed within the fourth connection portion. The first cavity, the second cavity, the third cavity, and the fourth cavity are in communication with one another, and the fourth cavity is in communication with the external environment.

In some embodiments, the sealing portion has a closed annular structure; or the sealing portion has an intermittent annular structure.

In some embodiments, the mounting box includes a battery box for receiving a battery, a control box with a control function, and/or a transducer box with a vibration function.

In some embodiments, the connection assembly includes an ear hook of a headphone and/or a rear hook of a headphone.

A headphone according to an embodiment of the present disclosure includes the connection structure as described in any one of the above embodiments.

In some embodiments, the headphone includes a bone conduction headphone and/or an air conduction headphone.

A headphone system according to an embodiment of the present disclosure includes the headphone as described in any one of the above embodiments, and a charging box configured to charge the headphone.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic perspective view of a headphone according to some embodiments of the present disclosure.

FIG. 2 is a schematic perspective view of a connection structure of the headphone of FIG. 1.

FIG. 3 is a schematic cross-sectional view of the connection structure of FIG. 2, taken along line III-III.

FIG. 4 is a schematic exploded perspective view of the connection structure of FIG. 2.

FIG. 5 is a schematic perspective view of a headphone system according to some embodiments of the present disclosure.

### DETAILED DESCRIPTION

In order to make the above objectives, features, and advantages of the present disclosure more apparent, specific embodiments of the present disclosure will be described in detail below with reference to the accompanying drawings. In the following description, many specific details are provided to facilitate full understanding of the present disclosure. However, the present disclosure can be implemented in other ways different from those described herein. Similar improvements can be made by those skilled in the art without contradicting the intent of the present disclosure. Therefore, the present disclosure is not limited by specific embodiments disclosed below.

In the description of the present disclosure, it should be understood that, the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features or more of the features. In the description of the present disclosure, “plurality” means at least two, unless otherwise specifically defined.

In the present disclosure, unless otherwise clearly specified and limited, terms such as “install”, “connect”, “connect to”, “fix” and the like should be understood in a broad sense. For example, it may be a fixed connection or a detachable connection or connection as one piece; mechanical connection or electrical connection; direct connection or indirect connection through an intermediate; internal communication of two components or the interaction relationship between two components, unless otherwise clearly limited. For those of ordinary skill in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

It should be noted that, when an element is described as being “fixed to” or “arranged on” another element, it may be directly on the other element or an intermediate element may exit. When an element is interpreted as being “connected” to another element, it may be directly connected to the other element or an intermediate element may exit simultaneously. As used herein, the terms “vertical”, “horizontal”, “over”, “below”, “left”, and “right” and similar expressions are used for illustrative purposes only and are not meant to be the only means of implementation.

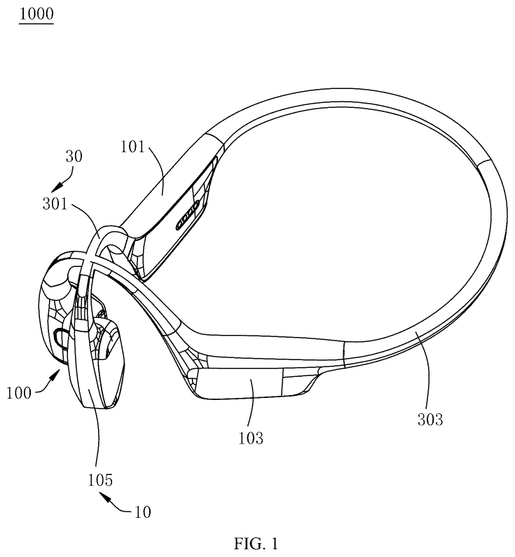

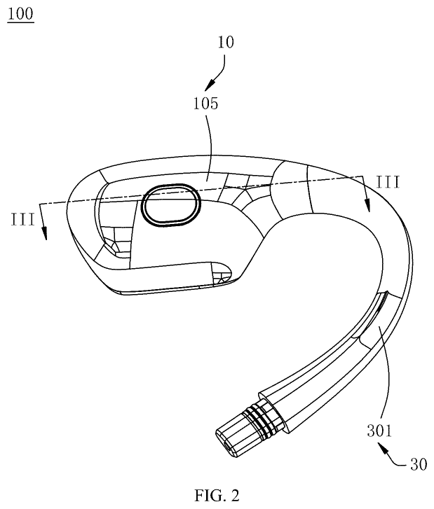

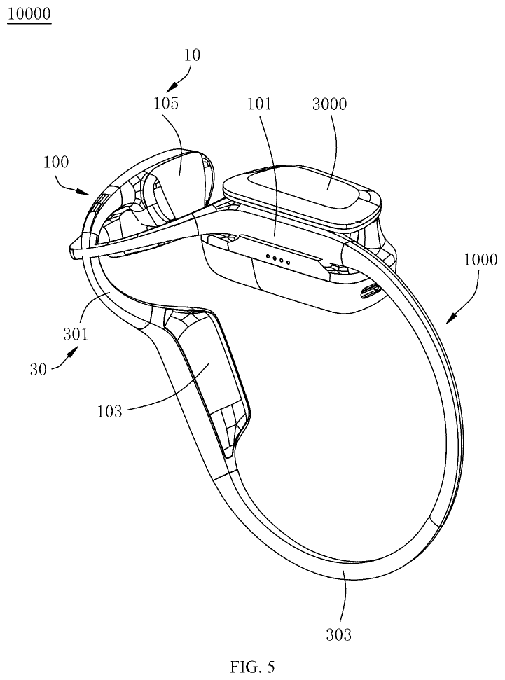

Typically, a transducer assembly (which may also be a battery box assembly or a control box assembly) is connected to an ear hook. Sealing between the transducer assembly and the ear hook is usually achieved by an additional sealing ring. In an example, the sealing is achieved through assembling the sealing ring onto the transducer assembly or the ear hook and then injecting a sealing adhesive. Due to the additional sealing ring and a consideration of the sealing adhesive, both labor and material costs are increased. In addition, waterproof performance is poor. As a result, a sound quality of the transducer assembly would be affected when an external liquid enters the transducer assembly. Therefore, embodiments of the present disclosure provide a connection structure 100 as illustrated in FIG. 2, a headphone 1000 as illustrated in FIG. 1, and a headphone system 10000 as illustrated in FIG. 5.

Referring to FIG. 1, a headphone 1000 according to an embodiment of the present disclosure includes a connection structure 100. In some embodiments, the headphone 1000 includes a bone conduction headphone 1000 and an air conduction headphone 1000.

The bone conduction headphone 1000 uses bones of a human body as a medium to convert sound into mechanical vibrations. The mechanical vibrations transmit sound waves through the bones of the human body in such a manner that the sound can be heard by a user. Since the sound from the bone conduction headphone 1000 acts on the bones, long-term use of the bone conduction headphone 1000 does not cause a significant impact on an eardrum of the user and therefore effectively protects hearing of the user. Sound is transmitted by the air conduction headphone 1000 through air vibrations, offering good sound quality and sound penetration. The headphone 1000 according to embodiments of the present disclosure will be described below by taking the bone conduction headphone 1000 as an example.

Referring to FIG. 2 to FIG. 4, the connection structure 100 according to an embodiment of the present disclosure includes a mounting box 10 and a connection assembly 30. The mounting box 10 has a connection hole 11 in communication with an external environment. The connection assembly 30 is connected to the mounting box 10. The connection hole 11 is configured to receive the connection assembly 30. The connection assembly 30 includes a connection body 31 and a connection member 33. At least part of the connection member 33 is sleeved on the connection body 31. The connection body 31 and the connection member 33 are integrally formed through two-color injection molding. The at least part of the connection member 33 sleeved on the connection body 31 protrudes in a direction away from the connection body 31 to form a sealing portion 331 of an annular shape. The sealing portion 331 abuts against a sidewall of the connection hole 11.

In some embodiments, referring to FIG. 1 and FIG. 2, the mounting box 10 is an arrangement configured to allow a battery, a circuit board, and other components of the headphone 1000 to be mounted in the mounting box 10. In some embodiments, the mounting box 10 includes a battery box 101 for receiving a battery, a control box 103 with a control function, and/or a transducer box 105 with a vibration function. In some embodiments, the mounting box 10 may include the control box 103. The control box 103 may be configured to control power-on, power-off, and a volume adjustment of the headphone 1000. In other embodiments, the mounting box 10 may include the battery box 101. The battery box 101 is configured to load the battery. The battery is configured to supply power to the headphone 1000, in such a manner that the headphone 1000 can operate normally. In yet other embodiments, the mounting box 10 may include the transducer box 105 within which a vibration assembly may be mounted. When the headphone 1000 is in use, the transducer box 105 may be attached to the human skin. When energized, the vibration assembly can drive the transducer box 105 to vibrate. A sound wave is transmitted by the transducer box 105 through the bones of the human body when the transducer box 105 vibrates, in such a manner that the sound can be heard by the user. In still yet other embodiments, the mounting box 10 may include the control box 103, the battery box 101, and the transducer box 105.

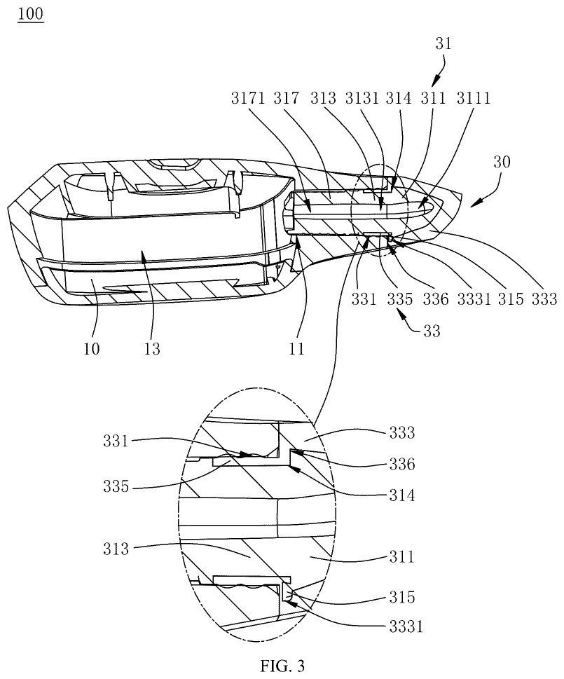

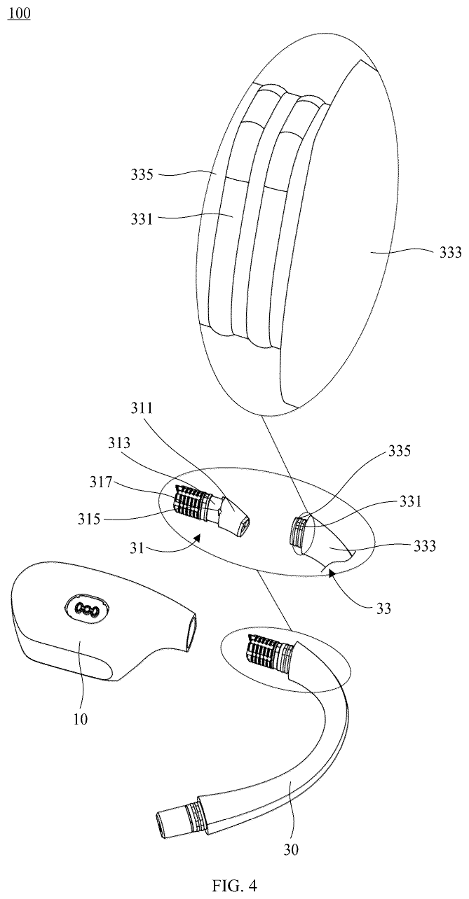

Referring to FIG. 3 and FIG. 4, the connection assembly 30 extends into the connection hole 11 to be connected to the mounting box 10. A wire may be disposed inside the connection assembly 30. When the connection assembly 30 is connected to the mounting box 10, the wire inside the connection assembly 30 may be electrically connected to components inside the mounting box 10. In some embodiments, the connection assembly 30 includes an ear hook 301 of the headphone 1000 and/or a rear hook 303 of a headphone 1000. When the user wears the headphone 1000, the rear hook 303 of the headphone 1000 is worn on the head, and the ear hook 301 of the headphone 1000 is worn over the ear, enhancing wearing stability of the headphone 1000. Thus, even when the user is outdoors or exercising, the headphone 1000 is less likely to fall off. The rear hook 303 is configured to connect the battery box 101 and the control box 103. The ear hook 301 is configured to connect the battery box 101 and the transducer box 105, and to connect the control box 103 and the transducer box 105.

In a case where the mounting box 10 is the transducer box 105, the connection assembly 30 may be the ear hook 301. In this case, the connection hole 11 is formed at an end of the mounting box 10. In a case where the mounting box 10 is the control box 103 or the battery box 101, the connection assembly 30 may include the ear hook 301 and the rear hook 303. In this case, the connection hole 11 may be formed at each of two opposite ends of the mounting box 10 in a length direction of the mounting box 10. One connection hole 11 of the mounting box 10 is configured to allow the ear hook 301 to extend into the one connection hole 11 of the mounting box 10, while the other connection hole 11 of the mounting box 10 is configured to allow the rear hook 303 to extend into the other connection hole 11 of the mounting box 10. As an example, the present disclosure will be described by taking the transducer box 105 as the mounting box 10 and the ear hook 301 as the connection assembly 30.

The connection member 33 is configured to mainly receive a wire of the headphone 1000. The connection body 31 is configured to mainly enable a stable connection between the connection assembly 30 and the mounting box 10. The at least part of the connection member 33 is sleeved on the connection body 31. When the at least part of the connection assembly 30 extends into the connection hole 11, at least part of the connection body 31 and at least part of the connection member 33 may both extend into the connection hole 11. The connection member 33 may be further configured to seal a gap between the connection assembly 30 and the sidewall of the connection hole 11.

In an embodiment of the present disclosure, the connection body 31 and the connection member 33 are made of different materials. In a case where the connection body 31 and the connection member 33 are integrally formed through the two-color injection molding, manufacturing of the connection assembly 30 involves few steps and is relatively simple. In addition, a connection between the connection body 31 and the connection member 33 is tight, and thus the connection body 31 and the connection member 33 are less likely to become loose.

Referring to FIG. 3 and FIG. 4, in some embodiments, the connection body 31 has greater hardness than the connection member 33. In this case, after the connection assembly 30 extends into the connection hole 11, connection strength between the connection assembly 30 and the mounting box 10 is high, and the connection assembly 30 is therefore less likely to detach from the mounting box 10. In a case where the connection body 31 has lower hardness than the connection member 33, the connection strength between the connection assembly 30 and the mounting box 10 is low, and the connection assembly 30 is therefore likely to detach from the mounting box 10, resulting in poor use experience of the user.

In some embodiments, the connection body 31 is made of polymer, and the connection member 33 is made of polymer. In a case where the connection body 31 is made of the polymer, when the connection body 31 is connected to the mounting box 10, the connection between the connection assembly 30 and the mounting box 10 is stable, and the connection strength between the connection assembly 30 and the mounting box 10 is high. When the connection member 33 is made of the polymer, an adjustment of a position or a shape of the connection member 33 by the user can be facilitated since the polymer can be easily deformed, in such a manner that the connection assembly 30 is more closely attached to the head of the user. The polymer may be, but is not limited to, rubber, silicone, thermoplastic elastomer, or polyvinyl chloride.

The part of the connection member 33 sleeved on the connection body 31 is provided with the sealing portion 331. The sealing portion 331 is configured to seal a gap between the connection assembly 30 and the connection hole 11 to prevent the external liquid from entering the mounting box 10 through the gap between the connection assembly 30 and the connection hole 11. When the connection assembly 30 is properly connected to the connection hole 11, the sealing portion 331 of the annular shape may abut against the entire sidewall of the connection hole 11. Since the sealing portion 331 is made of the polymer, the sealing portion 331 is compressed and deforms slightly when abutting against an inner wall of the connection hole 11. As a result, there is almost no gap between the sealing portion 331 and the sidewall of the connection hole 11, making it difficult for the external liquid to enter the mounting box 10 through the gap between the connection assembly 30 and the connection hole 11. Thus, the connection structure 100 has good waterproof performance. In addition, when the sealing portion 331 abuts against the sidewall of the connection hole 11, a large friction force exists between the sealing portion 331 and the sidewall of the connection hole 11, which therefore enhances connection stability between the connection assembly 30 and the mounting box 10. Thus, the connection assembly 30 is less likely to become loose relative to the mounting box 10. In the embodiments of the present disclosure, arranging the sealing portion 331 at the connection member 33 can effectively improve a waterproof rating of the connection structure 100, enhance the connection strength between the connection assembly 30 and the mounting box 10, and enable a simple structure, easy manufacturing, and convenient mounting of the connection assembly 30.

In the connection structure 100 according to the embodiments of the present disclosure, the connection body 31 and the connection member 33 are integrally formed through the two-color injection molding, and the at least part of the connection member 33 sleeved on the connection body 31 protrudes in a direction away from the connection body 31 to form the sealing portion 331 of the annular shape. Compared with a conventional connection structure 100, the connection structure 100 according to the embodiments of the present disclosure requires no sealing ring, and the connection between the connection assembly 30 and the mounting box 10 is simple, effectively saving the labor and material costs. Further, when the connection assembly 30 is connected to the mounting box 10, the sealing portion 331 abuts against the sidewall of the connection hole 11, resulting in high connection strength between the connection assembly 30 and the mounting box 10 and good waterproof performance of the connection structure 100. Therefore, the external liquid is less likely to flow into the mounting box 10 through the gap between the connection assembly 30 and the sidewall of the connection hole 11.

The connection structure 100 will be further described below in conjunction with the accompanying drawings.

Referring to FIG. 3 and FIG. 4, in some embodiments, the connection member 33 includes a body portion 333 and a protrusion 335 connected to the body portion 333. An outer side of the protrusion 335 is raised to form the sealing portion 331. The connection body 31 includes a first connection portion 311 and a second connection portion 313 connected to the first connection portion 311. The body portion 333 is sleeved on the first connection portion 311, and the protrusion 335 is sleeved on the second connection portion 313. The first connection portion 311 is provided with a protuberance 315 at a side of the first connection portion 311. The side of the first connection portion 311 is close to the second connection portion 313. The protuberance 315 extends towards the connection member 33. The body portion 333 has a recess 3331 formed on an inner side of the body portion 333. The protuberance 315 is engaged in the recess 3331.

When connecting the connection assembly 30 to the mounting box 10, the second connection portion 313 and the protrusion 335 extend into the connection hole 11, and the sealing portion 331 on the protrusion 335 abuts against the sidewall of the connection hole 11, achieving high connection strength between the connection assembly 30 and the mounting box 10 and good waterproof performance of the connection structure 100. During the two-color injection molding between the connection body 31 and the connection member 33, the body portion 333 may have the recess 3331 formed at a part of the body portion 333 corresponding to the protuberance 315 after the molten connection member 33 solidifies on a surface of the connection body 31. In a case where the first connection portion 311 is provided with the protuberance 315 at the side of the first connection portion 311 close to the second connection portion 313 and the body portion 333 has the recess 3331 formed on the inner side of the body portion 333, the protuberance 315 is engaged in the recess 3331, which can increase a connection area between the first connection portion 311 and the body portion 333. Therefore, connection strength between the connection body 31 and the connection member 33 can be enhanced, making the connection member 33 less likely to become loose relative to the connection body 31.

One, two, three, four, or more protuberances 315 may be provided, and the present disclosure is not limited in this regard. In a case where one protuberance 315 is provided, the one protuberance 315 may be disposed at any part of the first connection portion 311 at the side of the first connection portion 311 close to the second connection portion 313. Also, one recess 3331 may also be formed. A position of the recess 3331 corresponds to that of the protuberance 315. In this case, the connection body 31 has a simple structure and is easy to be manufactured. In a case where a plurality of protuberances 315 are provided, the plurality of protuberances 315 may be arranged uniformly or non-uniformly at the side of the first connection portion 311 close to the second connection portion 313. The number of recesses 3331 may be the same as that of protuberances 315. Positions of a plurality of recesses 3331 correspond to positions of the plurality of protuberances 315, respectively. In this case, the connection strength between the connection body 31 and the connection member 33 is relatively high.

Referring to FIG. 3 and FIG. 4, in some embodiments, the protuberance 315 and the body portion 333 both abut against a sidewall of the mounting box 10.

After the connection assembly 30 is properly mounted to the mounting box 10, an end of the body portion 333 close to the protrusion 335 abuts against an outer sidewall of the connection hole 11 (i.e., the sidewall of the mounting box 10), providing positioning for mounting of the connection assembly 30. In the embodiments of the present disclosure, the body portion 333 is made of the polymer. As a result, when the polymer (the body portion 333) abuts against the outer sidewall of the connection hole 11, abutment strength between the body portion 333 and the outer sidewall of the connection hole 11 is poor, resulting in an unsatisfactory positioning effect for the mounting of the connection assembly 30. Further, the external liquid is likely to flow into the connection hole 11 through a gap between the body portion 333 and the outer sidewall of the connection hole 11, leading to poor waterproof performance of the connection structure 100.

In a case where the first connection portion 311 is provided with the protuberance 315 and the protuberance 315 and the body portion 333 both abut against the outer sidewall of the connection hole 11, since the protuberance 315 is made of the polymer, the protuberance 315 and the body portion 333 can be both in hard contact with the outer sidewall of the connection hole 11. In this case, the connection strength between the connection assembly 30 and the mounting box 10 is relatively high. Further, the protrusion 335 and the body portion 333 provide a satisfactory positioning effect for the mounting of the connection assembly 30. After the connection assembly 30 is mounted in place, further extension of the connection assembly 30 towards the connection hole 11 can be effectively prevented. Furthermore, in the case where the protuberance 315 and the body portion 333 are in hard contact with the outer sidewall of the connection hole 11, there is almost no gap between the body portion 333 and the sidewall of the connection hole 11. Therefore, the external liquid is less likely to flow into the connection hole 11 through the gap between the body portion 333 and the outer sidewall of the connection hole 11, leading to good waterproof performance of the connection structure 100.

Referring to FIG. 3 and FIG. 4, in some embodiments, a plurality of sealing portions 331 are provided. The plurality of sealing portions 331 are arranged sequentially at intervals in an extension direction of the protrusion 335. As an example, two, three, four, or more sealing portions 331 may be provided. In a case where a plurality of sealing portions 331 are provided, each of the plurality of sealing portions 331 abuts against the sidewall of the connection hole 11. In this way, a tight connection is achieved between the connection assembly 30 and the inner wall of the connection hole 11, leading to relatively high connection strength between the connection assembly 30 and the mounting box 10. In addition, the waterproof performance of the connection structure 100 can be further enhanced, and thus the external liquid is less likely to enter the mounting cavity 13.

Referring to FIG. 3 and FIG. 4, in some embodiments, the sealing portion 331 has a closed annular structure. In this case, the sealing portion 331 has a simple structure and is easy to be manufactured. In addition, the sealing portion 331 can abut against an entire circumference of the inner wall of the connection hole 11, leading to good waterproof performance of the connection structure 100. In other embodiments, the sealing portion 331 has an intermittent annular structure. In this case, the sealing portion 331 is formed by less material, which can save the material.

Referring to FIG. 3 and FIG. 4, in some embodiments, a first shoulder 314 is formed between the first connection portion 311 and the second connection portion 313, and a second shoulder 336 is formed between the body portion 333 and the protrusion 335. The first shoulder 314 is engaged with the second shoulder 336.

The first connection portion 311 has a greater outer diameter than the second connection portion 313, which can enable the first shoulder 314 to be formed at a connection between the first connection portion 311 and the second connection portion 313. The body portion 333 may have a greater outer diameter than the protrusion 335, which can enable the second shoulder 336 to be formed at a connection between the body portion 333 and the protrusion 335. When the first shoulder 314 is engaged with the second shoulder 336, a connection area between the connection member 33 and the connection body 31 can be increased. Therefore, connection strength between the connection member 33 and the connection body 31 can be further enhanced, making the connection member 33 less likely to become loose relative to the connection body 31.

Further, when the first shoulder 314 is engaged with the second shoulder 336, the connection assembly 30 has a stepped surface formed on a side of the body portion 333 close to the protrusion 335. During extending the connection assembly 30 into the connection hole 11, the stepped surface can be used to position the connection assembly 30. When the stepped surface abuts against the outer sidewall of the connection hole 11, the connection assembly 30 is properly mounted to the mounting box 10. In this way, simple mounting is realized between the connection assembly 30 and the mounting box 10, which can effectively avoid a problem of misalignment of the mounting between the connection assembly 30 and the mounting box 10.

Referring to FIG. 3 and FIG. 4, further, in some embodiments, the connection body 31 further includes a third connection portion 317 extending from the second connection portion 313. The third connection portion 317 is connected to the sidewall of the connection hole 11 by a sealing adhesive. The third connection portion 317 has a wave pattern formed on an outer sidewall of the third connection portion 317. The wave pattern is configured to enhance the bonding strength of the sealing adhesive.

In a case where the third connection portion 317 is connected to the sidewall of the connection hole 11 by the sealing adhesive, the connection between the connection assembly 30 and the mounting box 10 becomes more stable, making the connection assembly 30 less likely to become loose relative to the mounting box 10. Further, the external liquid is less likely to enter the mounting box 10 through a gap between the third connection portion 317 and the sidewall of the connection hole 11. In the embodiments of the present disclosure, a first waterproof structure may be formed through an abutment between the sealing portion 331 and the sidewall of the connection hole 11, while a second waterproof structure may be formed among the third connection portion 317, the sealing adhesive, and the sidewall of the connection hole 11. As a result, the connection structure 100 provides better waterproof performance, which makes the external liquid less likely to enter the mounting box 10 through the connection hole 11, avoiding a problem that the external liquid affects normal operation of the components inside the mounting box 10.

Referring to FIG. 3 and FIG. 4, further, in some embodiments, the mounting box 10 has a mounting cavity 13 in communication with the connection hole 11. The connection body 31 further includes a fourth connection portion extending from the third connection portion 317. The fourth connection portion is a engagement hook. The fourth connection portion extends into the mounting cavity 13 to engage with an inner sidewall of the connection hole 11.

The mounting cavity 13 is configured to allow the battery, the circuit board, and other components of the headphone 1000 to be mounted in the mounting cavity 13. In a case where the connection assembly 30 is properly connected to the mounting box 10, the fourth connection portion may extend into the mounting cavity 13. The fourth connection portion is connected to an end of the third connection portion 317. The fourth connection portion and the third connection portion 317 may have an integral structure or separate structures. In a case where the fourth connection portion and the third connection portion 317 have the integral structure, the fourth connection portion and the third connection portion 317 may be integrally formed, which realizes simple manufacturing steps of the connection assembly 30 and a stable connection between the fourth connection portion and the third connection portion 317. In a case where the fourth connection portion and the third connection portion 317 have the separate structures, the fourth connection portion and the third connection portion 317 may be detachably or non-detachably connected to each other. Detachable mounting methods may include, but are not limited to, threaded connection, screw connection, snap-fit connection, etc. Non-detachable mounting methods may include, but are not limited to, welding, adhesive connection, interference fit, etc.

In a case where the third connection portion 317 extends into the connection hole 11, the third connection portion 317 may drive the fourth connection portion to extend together into the connection hole 11. In a case where the connection assembly 30 is mounted in place, the fourth connection portion may extend into the mounting cavity 13. In a case where the fourth connection portion is the engagement hook, the engagement hook may abut against the inner sidewall of the connection hole 11. In this case, the engagement between the fourth connection portion and the inner sidewall of the connection hole 11 can effectively restrict a movement of the connection assembly 30 away from the mounting box 10. After the connection assembly 30 is properly mounted to the mounting box 10, the stepped surface of the body portion 333 is used to restrict a further movement of the connection assembly 30 towards the mounting cavity 13, and the fourth connection portion is used to restrict the movement of the connection assembly away from the mounting box 10. Thus, the stable connection is realized between the connection assembly 30 and the mounting box 10, and thus the connection assembly 30 is less likely to become loose relative to relative to the mounting box 10.

Referring to FIG. 3 and FIG. 4, in some embodiments, the third connection portion 317 has a third cavity 3171 formed within the third connection portion 317. The connection structure 100 further includes a fixing member. A part of the fixing member extends into the third cavity 3171, and the other part of the fixing member tightly presses the third connection portion 317 against the sidewall of the connection hole 11. The fixing member may be a pin. After the connection assembly 30 is mounted in place, the pin may extend into the third cavity 3171 and tightly press the third connection portion 317 against the sidewall of the connection hole 11. In this way, connection strength between the third connection portion 317 and the mounting box 10 can be further enhanced, strengthening the connection strength between the connection assembly 30 and the mounting box 10.

Referring to FIG. 3 and FIG. 4, in some embodiments, the third connection portion 317 has a third cavity 3171 formed within the third connection portion 317, and the fourth connection portion has a fourth cavity formed within the fourth connection portion. The fourth cavity is in communication with the third cavity 3171. The fourth cavity is configured to provide a deformation space for a force-induced deformation of the fourth connection portion during insertion of the fourth connection portion into the connection hole 11. The fourth connection portion is configured to, when being inserted in the connection hole in place, restore to an initial shape of the fourth connection portion to engage with the inner sidewall of the connection hole 11.

The engagement hook (fourth connection portion) may have a greater outer diameter than the connection hole 11. Thus, in a case where the engagement hook is located within the mounting cavity 13, the engagement hook may engage with the inner sidewall of the connection hole 11. During extending the connection assembly 30 into the connection hole 11, the engagement hook is pressed by the sidewall of the connection hole 11 and can therefore deform towards the fourth cavity. In a case where the third cavity 3171 is in communication with the fourth cavity, a deformation of the engagement hook may drive the third connection portion 317 to deform towards the third cavity 3171, and vice versa, a deformation of the third connection portion 317 may also drive the engagement hook to deform. Thus, when the engagement hook is pressed by the sidewall of the connection hole 11, the deformation of the engagement hook is easy, which can facilitate an extension of the engagement hook into the mounting cavity 13. In a case where the engagement hook passes through the connection hole 11 and enters the mounting cavity 13, since the engagement hook is no longer pressed, the engagement hook can restore to its initial shape to engage with the inner sidewall of the connection hole. In a case where the third connection portion 317 has the third cavity 3171 and the fourth connection portion has the fourth cavity, an extension of the fourth connection portion through the connection hole 11 into the mounting cavity 13 can be facilitated.

Referring to FIG. 3 and FIG. 4, in some embodiments, the first connection portion 311 has a first cavity 3111 formed within the first connection portion 311. The second connection portion 313 has a second cavity 3131 formed within the second connection portion 313. The third connection portion 317 has a third cavity 3171 formed within the third connection portion 317. The fourth connection portion has a fourth cavity formed within the fourth connection portion. The first cavity 3111, the second cavity 3131, the third cavity 3171, and the fourth cavity are in communication with one another. The fourth cavity is in communication with the external environment. In this case, the connection body 31 can be formed easily with less material, which can save on material costs and realize a light overall weight of the connection assembly 30. Thus, the headphone 1000 as a whole is light, which facilitates picking up, placing, and carrying of the headphone 1000, providing good use experience.

Referring to FIG. 5, a headphone system 10000 according to an embodiment of the present disclosure includes the headphone 1000 as described in any one of the above embodiments and a charging box 3000 configured to charge the headphone 1000. The charging box 3000 has a charging compartment. When the headphone 1000 needs to be charged, the battery box 101 of the headphone 1000 may be received within the charging compartment, allowing the charging box 3000 to charge the battery inside the battery box 101.

In the headphone system 10000 according to the embodiment of the present disclosure, the connection body 31 and the connection member 33 are integrally formed through the two-color injection molding, and the at least part of the connection member 33 sleeved on the connection body 31 protrudes in a direction away from the connection body 31 to form the sealing portion 331 of the annular shape. Compared with a conventional connection structure 100, the connection structure 100 according to the embodiments of the present disclosure requires no sealing ring, and the connection between the connection assembly 30 and the mounting box 10 is simple, effectively saving the labor and material costs. Further, when the connection assembly 30 is connected to the mounting box 10, the sealing portion 331 abuts against the sidewall of the connection hole 11, resulting in high connection strength between the connection assembly 30 and the mounting box 10 and good waterproof performance of the connection structure 100. Therefore, the external liquid is less likely to flow into the mounting box 10 through the gap between the connection assembly 30 and the sidewall of the connection hole 11.

Technical features in the above embodiments can be combined arbitrarily. For concise description, not all possible combinations of the technical features in the above embodiments are described. However, any combination of the technical features in the above embodiments should be considered as falling within the scope of the present disclosure, as long as no conflict occurs between combinations of the technical features. Also, other embodiments can be derived from the above embodiments, such that structural and logical substitutions and changes can be made without departing from the scope of the present disclosure.

While several embodiments of the present disclosure have been described above in a specific and detailed manner, the scope of the present disclosure cannot be construed as being limited to these embodiments. It should be noted that, those of ordinary skill in the art can make various variants and modifications without departing from the concept of the present disclosure, and these variants and modifications shall fall within the scope of present disclosure as defined in the appended claims.

What is claimed is:

1. A connection structure, comprising:
a mounting box having a connection hole in communication with an external environment; and
a connection assembly connected to the mounting box, the connection hole being configured to receive the connection assembly, and the connection assembly comprising a connection body and a connection member, wherein:
at least part of the connection member is sleeved on the connection body;
the connection body and the connection member are integrally formed through two-color injection molding; and
the at least part of the connection member sleeved on the connection body protrudes in a direction away from the connection body to form a sealing portion of an annular shape, the sealing portion abutting against a sidewall of the connection hole.

2. The connection structure according to claim 1, wherein the connection body has greater hardness than the connection member.

3. The connection structure according to claim 2, wherein:
the connection body is made of polymer; and
the connection member is made of polymer.

4. The connection structure according to claim 1, wherein:
the connection member comprises a body portion and a protrusion connected to the body portion, an outer side of the protrusion protruding to form the sealing portion; and
the connection body comprises a first connection portion and a second connection portion connected to the first connection portion, the body portion being sleeved on the first connection portion, and the protrusion being sleeved on the second connection portion, wherein:
the first connection portion is provided with a protuberance at a side of the first connection portion, the side of the first connection portion being close to the second connection portion, and the protuberance extending towards the connection member; and
the body portion has a recess formed on an inner side of the body portion, the protuberance being engaged in the recess.

5. The connection structure according to claim 4, wherein the protuberance and the body portion both abut against a sidewall of the mounting box.

6. The connection structure according to claim 4, wherein a plurality of sealing portions are provided, the plurality of sealing portions being arranged sequentially at intervals in an extension direction of the protrusion.

7. The connection structure according to claim 4, wherein:
a first shoulder is formed between the first connection portion and the second connection portion; and
a second shoulder is formed between the body portion and the protrusion, the first shoulder being engaged with the second shoulder.

8. The connection structure according to claim 4, wherein the connection body further comprises a third connection portion extending from the second connection portion, wherein:
the third connection portion is connected to the sidewall of the connection hole by a sealing adhesive; and
the third connection portion has a wave pattern formed on an outer sidewall of the third connection portion, the wave pattern being configured to enhance bonding strength of the sealing adhesive.

9. The connection structure according to claim 8, wherein:
the mounting box has a mounting cavity in communication with the connection hole; and
the connection body further comprises a fourth connection portion extending from the third connection portion, the fourth connection portion being an engagement hook and extending into the mounting cavity to engage with an inner sidewall of the connection hole.

10. The connection structure according to claim 8, wherein:
the third connection portion has a third cavity formed within the third connection portion; and
the connection structure further comprises a fixing member, a part of the fixing member extending into the third cavity, and the other part of the fixing member pressing the third connection portion against the sidewall of the connection hole.

11. The connection structure according to claim 9, wherein:
the third connection portion has a third cavity formed within the third connection portion; and
the fourth connection portion has a fourth cavity formed within the fourth connection portion, the fourth cavity being in communication with the third cavity, wherein the fourth cavity is configured to provide a deformation space for a force-induced deformation of the fourth connection portion during insertion of the fourth connection portion into the connection hole, and wherein the fourth connection portion is configured to, when being inserted in the connection hole in place, restore to an initial shape of the fourth connection portion to engage with the inner sidewall of the connection hole.

12. The connection structure according to claim 9, wherein:
the first connection portion has a first cavity formed within the first connection portion;
the second connection portion has a second cavity formed within the second connection portion;
the third connection portion has a third cavity formed within the third connection portion; and
the fourth connection portion has a fourth cavity formed within the fourth connection portion, wherein:
the first cavity, the second cavity, the third cavity, and the fourth cavity are in communication with one another; and
the fourth cavity is in communication with the external environment.

13. The connection structure according to claim 1, wherein:
the sealing portion has a closed annular structure; or
the sealing portion has an intermittent annular structure.

14. The connection structure according to claim 1, wherein the mounting box comprises a battery box for receiving a battery, a control box with a control function, and/or a transducer box with a vibration function.

15. The connection structure according to claim 1, wherein the connection assembly comprises an ear hook of a headphone and/or a rear hook of a headphone.

16. A headphone, comprising the connection structure according to claim 1.

17. The headphone according to claim 16, wherein the mounting box comprises a battery box for receiving a battery, a control box with a control function, and/or a transducer box with a vibration function.

18. The headphone according to claim 16, wherein the connection assembly comprises an ear hook of a headphone and/or a rear hook of a headphone
19. The headphone according to claim 16, wherein the headphone comprises a bone conduction headphone and/or an air conduction headphone.

20. A headphone system, comprising:
the headphone according to claim 16; and
a charging box configured to charge the headphone.
